(19) United States
(12) Patent Application Publication
(10) Pub. No.: US 2018/0154552 A1
(43) Pub. Date: Jun. 7, 2018

(54) GRINDING BLOCK OF DRY GRINDING MACHINE FOR GRINDING CONCRETE AND GRANITE

(71) Applicant: Jiaxiang HOU, Xiamen (CN)

(72) Inventor: Jiaxiang HOU, Xiamen (CN)

(21) Appl. No.: 15/583,333

(22) Filed: May 1, 2017

(30) Foreign Application Priority Data
Dec. 1, 2016 (CN) 201611089593.9

(51) Int. Cl. B28D 1/18; E21C 35/18

(52) U.S. Cl. CPC B28D 1/186; E21C 35/18

(57) ABSTRACT

The present invention is provided with a grinding block of dry grinding machine for grinding concrete and granite, the grinding block is assembled to a mill of the grinding machine, the grinding block comprises a fixing plate to fix the grinding block to the mill, wherein the fixing plate is welded with a grinding media, the grinding media comprises a plurality of grinding pieces, the grinding pieces are connected by a connecting strip or connecting strips arranged with space, the connecting strips with spaces divide with a plurality of air passages between two grinding pieces.

### FIELD OF THE INVENTION

The present invention relates to construction machinery, especially to a grinding block of dry grinding machine for grinding concrete and granite.

### BACKGROUND OF THE INVENTION

The concrete ground is needed to be grinded and polished by grinding machine during the construction, and the grinding block with diamond at the bottom portion of the grinding machine grinds the ground repeat and repeat. Existing grinding block assembled to the grinding machine is disclosed in FIG. 1a and FIG. 1b, the grinding media B is welded to a fixing plate A, the fixing plate A is assembled to the mill at the bottom of the grinding machine by welding or screwing, the mill rotates to drive the grinding block to grind the ground, the grinding block contains diamond particles, diamond particles are added the basic material and sintered to form the grinding block, the grinding block is an integral structure. During the grinding, as the grinding is dry grinding, the grinding block grinds the ground in high speed, an enormous amount of heat generates. But existing grinding block is an integral grinding media that it doesn't have heat dissipation structure, overheated working would happen and the service life is influenced under the enormous amount of heat.

### SUMMARY OF THE INVENTION

The present invention is provided with a grinding block of grinding machine of keenness, high efficiency and long service life.

The technical solution of the present invention is that:

A grinding block of dry grinding machine for grinding concrete and granite, the grinding block is assembled to a mill of the grinding machine, the grinding block comprises a fixing plate to fix the grinding block to the mill, wherein the fixing plate is welded with a grinding media, the grinding media comprises a plurality of grinding pieces, the grinding pieces are connected by a connecting strip or connecting strips arranged with space, diamond particles are embedded to the grinding piece.

The connecting strips with spaces divide with a plurality of air passages between two grinding pieces.

In another preferred embodiment, the at least one grinding piece is disposed with at least one hole, the hole can be served as air hole, therefore, during the grinding machine grinds the ground, the grinding block rotates in high speed by the driving of the mill, air flows fast between the air holes and the air passages formed in the intervals of the connecting strips, thus greatly decreasing the temperature of the grinding block.

In another preferred embodiment, the grinding piece and the connecting strip are made of material containing diamond.

In another preferred embodiment, the grinding piece and the connecting strip are arranged vertically to the fixing plate.

In another preferred embodiment, the grinding piece and the connecting strip are arranged parallel to the fixing plate.

The present invention has advantages: the structure is simple, the grinding block is disposed with air passages and air holes compared to the traditional one, the cooling function during grinding is improved, and the keenness, the working efficiency and the service life of the grinding block are greatly improved.

### BRIEF DESCRIPTION OF THE DRAWINGS

FIG. 1a and FIG. 1b illustrates a schematic diagram of two existing grinding blocks.

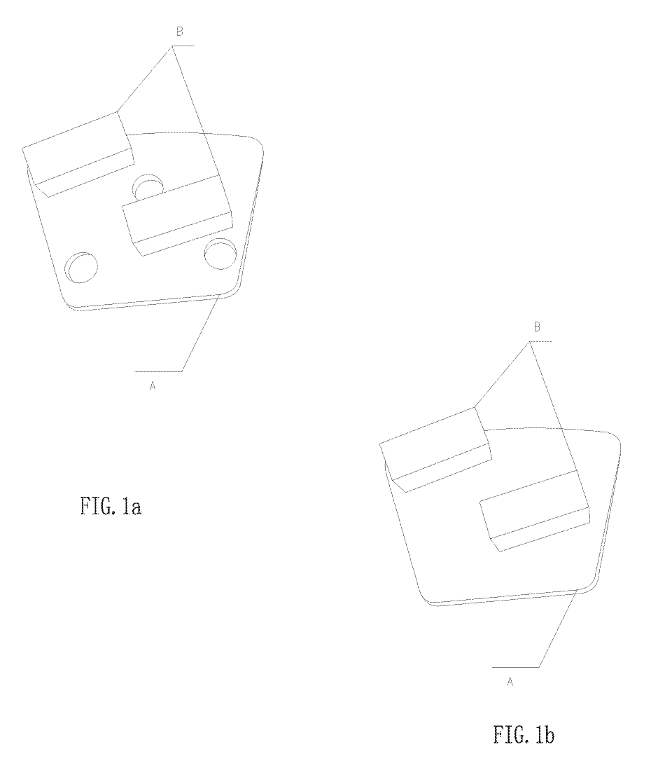

FIG. 2 illustrates a schematic diagram of a grinding block of a first embodiment of the present invention.

FIG. 3 illustrates a schematic diagram of a grinding block of a second embodiment of the present invention.

FIG. 4 illustrates a schematic diagram of a grinding block of a third embodiment of the present invention.

FIG. 5 illustrates a schematic diagram of a grinding block of a fourth embodiment of the present invention.

FIG. 6 illustrates a schematic diagram of a grinding block of a fifth embodiment of the present invention.

FIG. 7 illustrates a schematic diagram of a grinding block of a sixth embodiment of the present invention.

### DETAILED DESCRIPTION OF THE EMBODIMENTS

The present invention will be further described with the drawings and the embodiments.

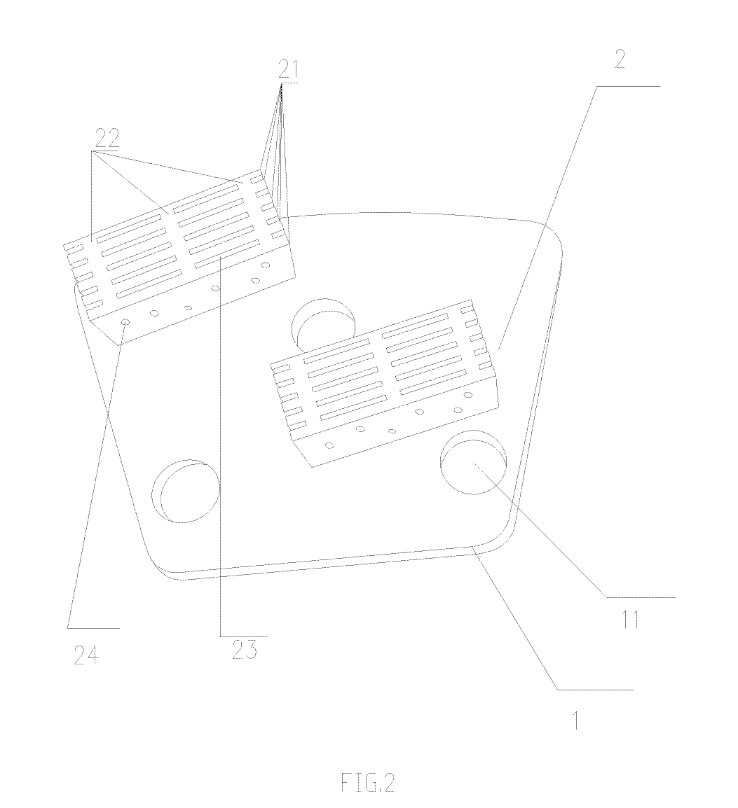

As figured in FIG. 2, a grinding block of dry grinding machine for grinding concrete and granite comprises a fixing plate 1, the fixing plate 1 is disposed with a plurality of fixing holes 11, the fixing plate 1 is connected to a mill of a grinding machine by the fixing holes. In another embodiment, the fixing hole 11 can be omitted, the fixing plate is directly welded to the mill of the grinding machine.

The fixing plate 1 is welded with a plurality of grinding medias 2, the number of the grinding medias are adjustable as needed, in this embodiment, there are two grinding medias. The grinding media 2 comprises a plurality of grinding pieces 21, the grinding pieces 2 are fixed by welding a plurality of connecting strips 22 arranged with space, thus increasing the stability of the grinding media; the grinding piece 21 are made of material containing diamond, making the grinding piece with well grinding performance, the connecting strip is disposed with diamond particles. As the connecting strips 22 are disposed with space between the grinding pieces, a plurality of interval spaces 23 are formed between the grinding pieces and the connecting strips, the interval spaces 23 served as air passages to cool the mold can improve the keenness and the efficiency and thus lengthen the service life of the mold during the grinding machine grinding the ground. In addition, in this embodiment, the grinding piece 21 and the connecting strips are arranged vertically to the fixing plate, the integral structure is cuboid shaped or teeth shaped, in this embodiment, the grinding piece 22 can be disposed with one or more than one air hole 24, therefore, during the grinding machine grinds the ground, the grinding block rotates in high speed by the driving of the mill, air flows fast between the air holes 24 and the air passages formed in the intervals 23 of the connecting strips, thus greatly decreasing the temperature of the grinding block.

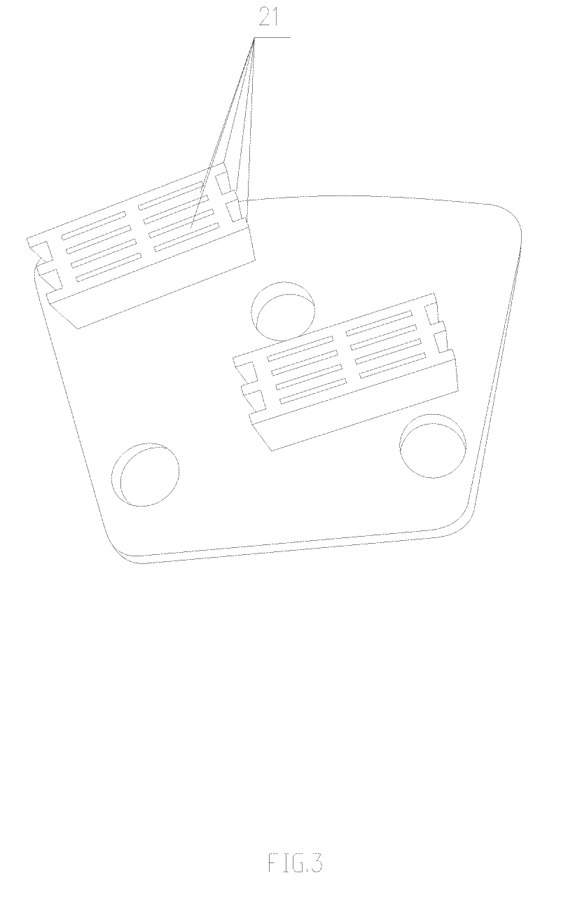

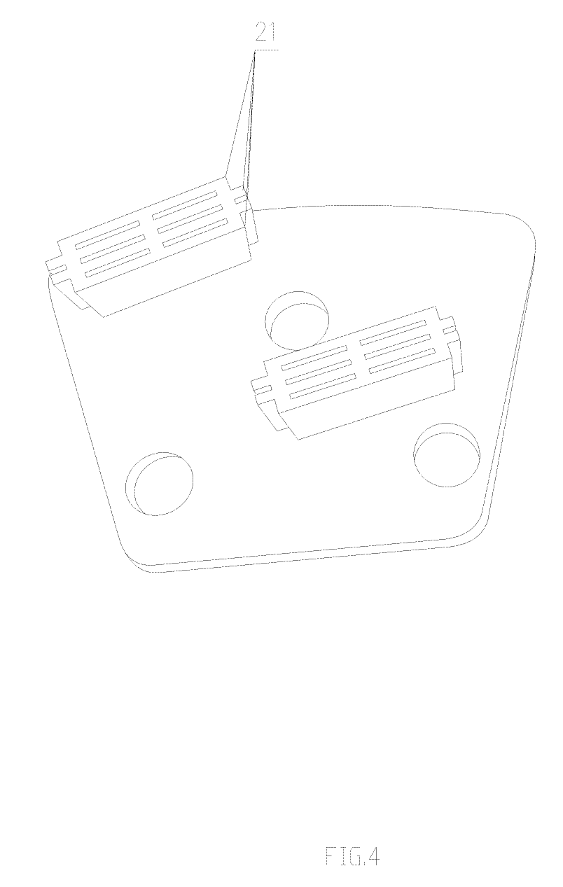

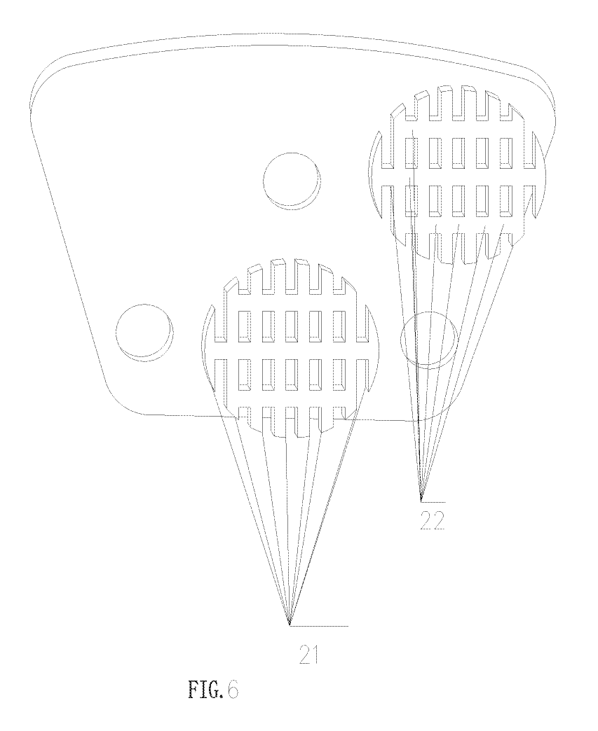

In addition, the arrangement of the grinding pieces 21 can apply with the methods as figured in FIG. 3 and FIG. 4, that is to say, the length of each grinding piece can be different, only if the grinding pieces can be welded by the connecting strips. The keenness and the efficiency are greatly improved with the length difference of each grinding piece, as figured in FIG. 6, a fifth embodiment of the present invention is provided, the grinding media is cylinder shaped, the grinding area and the air exhausting area are increased.

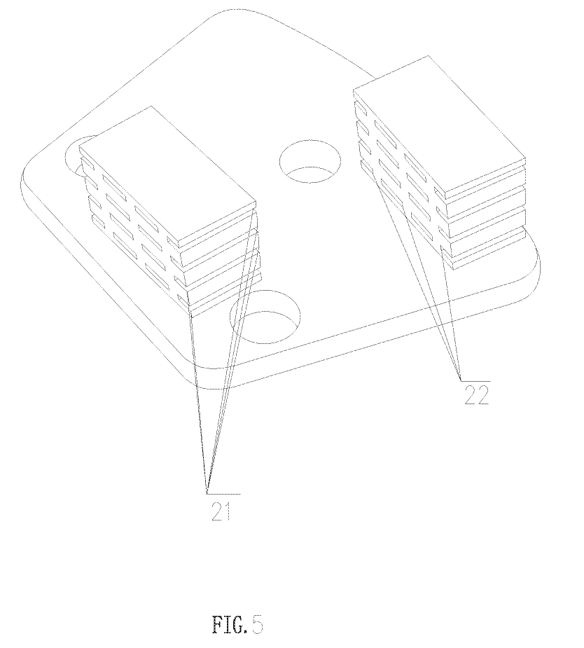

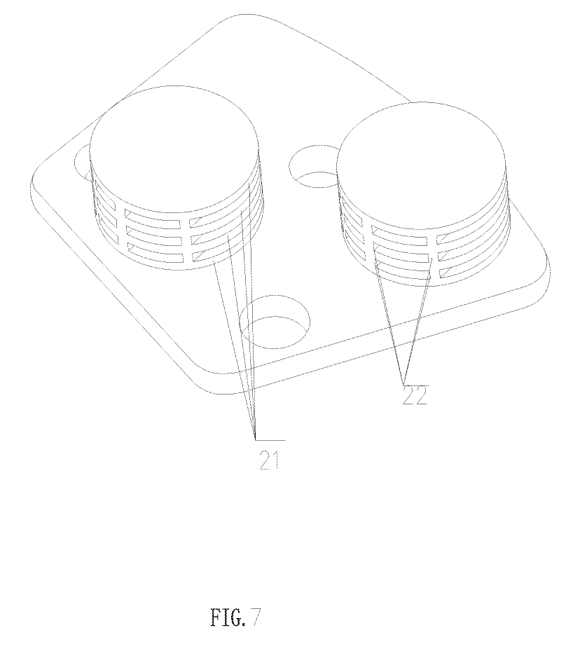

In another embodiment of the present invention, as figured in FIG. 5 and FIG. 7, the grinding piece 21 and the connecting strip 22 are arranged parallel to the fixing plate 1. during high speed grinding, the interval spaces formed between the connecting strips 22 achieve well air exhausting effect, thus greatly decreasing the temperature of the grinding block. In addition, as the connecting strips are made of the same grinding material, after the first layer of grinding pieces wears out, the connecting strips have well grinding performance that they can be served as next grinding layer, therefore, the grinding effect of the grinding block is not influenced and the cooling effect of the grinding block is greatly increased, thus lengthening the service life of the grinding block.

1. A grinding block of dry grinding machine for grinding concrete and granite, the grinding block is assembled to a mill of the grinding machine, the grinding block comprises a fixing plate to fix the grinding block to the mill, wherein the fixing plate is welded with a grinding media, the grinding media comprises a plurality of grinding pieces, the grinding pieces are connected by a connecting strip or connecting strips arranged with space, diamond particles are embedded to the grinding piece.

2. The grinding block of dry grinding machine for grinding concrete and granite according to claim 1, wherein the grinding pieces are disposed with air passages therebetween.

3. The grinding block of dry grinding machine for grinding concrete and granite according to claim 1, wherein the fixing plate is disposed with a connecting hole.

4. The grinding block of dry grinding machine for grinding concrete and granite according to claim 1, wherein the grinding piece and the connecting strip are arranged vertically to the fixing plate.

5. The grinding block of dry grinding machine for grinding concrete and granite according to claim 1, wherein the grinding piece and the connecting strip are arranged parallel to the fixing plate.

6. The grinding block of dry grinding machine for grinding concrete and granite according to claim 4, wherein the grinding piece is cuboid shaped.

7. The grinding block of dry grinding machine for grinding concrete and granite according to claim 4, wherein the grinding piece is cylinder shaped.

8. The grinding block of dry grinding machine for grinding concrete and granite according to claim 1, wherein at least one grinding piece is disposed with at least one hole.

9. The grinding block of dry grinding machine for grinding concrete and granite according to claim 5, wherein the grinding piece is cuboid shaped.

10. The grinding block of dry grinding machine for grinding concrete and granite according to claim 5, wherein the grinding piece is cylinder shaped.
